(19) United States
(12) Patent Application Publication
(10) Pub. No.: US 2002/0037427 A1
(43) Pub. Date: Mar. 28, 2002

(54) Organic light emitting device material, amine compound, heterocyclic compound and organic light emitting devices using the same

(76) Inventor: Toshiki Taguchi, Kanagawa (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 09/820,878

(22) Filed: Mar. 30, 2001

(30) Foreign Application Priority Data
Mar. 31, 2000 (JP) P.2000-098821
Mar. 31, 2000 (JP) P.2000-098913

(51) Int. Cl. H05B 33/14; C09K 11/06

(52) U.S. Cl. 428/690; 428/917; 313/504; 313/506; 252/301.16; 540/1; 564/1; 428/704

(57) ABSTRACT

An organic light emitting device material comprises at least one compound having at least two asymmetric carbon atoms per a molecule.

### FIELD OF THE INVENTION

The present invention relates to an organic light emitting material which enables the production of organic light emitting devices having great durability, novel amine compounds, novel heterocyclic compounds, and organic light emitting devices using them.

### BACKGROUND ART

Nowadays, researches and developments in various display devices are being actively made of such devices, the organic electric-field luminescent (EL) devices are receiving particular attention as promising display devices because they can emit light of high intensity under low voltage. For instance, the EL devices having organic thin films formed by vapor deposition of organic compounds are known (Applied Physics Letters, 51, from p. 913 on (1987)). Each of the organic EL devices described in the literature cited above has a multilayer structure of an electron transport material and a hole transport material, and thereby shows substantial improvements in its light emitting characteristics over conventional single-layer devices.

With respect to the hole transport materials used for such multilayer devices, triarylamine derivatives represented by N,N′-di-m-tolyl-N,N′-diphenylbenzidine (TPD) and π-electron-rich aromatic compounds, such as pyrrole, carbazole and thiophene, are known as excellent hole transport materials. However, the organic light emitting devices utilizing those compounds as hole transport materials are already known to have a problem of being subject to a considerable deterioration in device performances during the storage, particularly the storage under high temperatures, because of their high crystallinity.

As means to solve such a problem, in the case of triarylamine derivatives, the art of introducing thereto condensed polycyclic aromatic groups and the art of using compounds increased in symmetry are disclosed, e.g., in Appl. Phys. Lett., 56, 799 (1990) and Polymer Preprints (ACS), 349 (1997). In the case of nitrogen-containing heterocyclic compounds including carbazole derivatives, on the other hand, the studies of similar arts to the above have been made, and the arts of converting those compounds into polymeric compounds are disclosed, e.g., in Appl. Phys. Lett., 63, 2627 (1993).

Hitherto, the present inventors also have studied arts of reducing the hole transport material-derived deterioration in storage stability of organic light emitting devices.

With respect to the electron transport materials used for such multilayer devices disclosed in Applied Physics Letters, 51, from p. 913 on (1987), light metal complexes represented by tris(8-hydroxyquinolinato)aluminum (Alq) and π-electron deficient aromatic compounds, such as oxadiazole, triazole, benzimidazole, benzoxazole and benzothiazole, are known as excellent electron transport materials. However, when organic light emitting devices utilize π-electron deficient aromatic compounds as electron transport materials in particular, these devices are already known to have a problem of being subject to a considerable deterioration in device performances during the storage, particularly the storage under high temperatures.

As means to solve such a problem, the art of introducing condensed polycyclic aromatic groups into those compounds and the art of using compounds increased in symmetry are disclosed, e.g. in Appl. Phys. Lett., 56, 799 (1990) and Polymer Preprints (ACS), 349 (1997). Further, the arts of converting those compounds into polymeric compounds are disclosed, e g., in Appl. Phys. Lett., 63, 2627 (1993).

Hitherto, the present inventors also have studied arts of reducing the electron transport material-derived deterioration in storage stability of organic light emitting devices.

### SUMMARY OF THE INVENTION

It is an object of the invention to develop a hole-transporting compound with great durability and provide an organic light emitting device having high luminance and excellent storage stability.

It is another object of the invention to develop an electron-transporting compound with great durability and provide an organic light emitting device having high luminance and excellent storage stability.

The objects of the invention are attained with the following organic light emitting device materials, amine compounds, heterocyclic compounds and organic light emitting devices:

1) An organic light emitting device material comprising at least one compound having at least two asymmetric carbon atoms per a molecule.

2) The organic light emitting device material according to item 1), wherein the compound comprises at least one primary, secondary or tertiary amine moiety.

3) The organic light emitting device material according to item 1) wherein the compound is a π-electron-rich condensed or uncondensed aromatic heterocyclic compound having at least two asymmetric carbon atoms per a molecule.

4) The organic light emitting device material according to item 3), wherein the compound is a hole-transporting compound.

5) The organic light emitting device material according to item 1), wherein the compound is an electron-deficient aromatic heterocyclic compound having at least two asymmetric carbon atoms per a molecule.

6) The organic light emitting device material according to item 5), wherein the compound is an electron-transporting compound.

7) The organic light emitting device material according to item 5), wherein the electron-deficient aromatic heterocyclic compound comprises at least one condensed or uncondensed 5-membered aromatic heterocyclic ring in which at least two hetero atoms including at least one nitrogen atom are contained.

8) The organic light emitting device material according to item 5), wherein the electron-deficient aromatic heterocyclic compound comprises at least one condensed or uncondensed nitrogen-containing 6-membered aromatic heterocyclic ring.

9) The organic light emitting device material according to item 1), wherein the compound has a molecular weight of from 100 to 10,000.

10) An organic light emitting device comprising one pair of electrodes and at least one layer between the electrodes, wherein the layer comprises at least one compound having at least two asymmetric carbon atoms per a molecule.

11) The organic light emitting device according to itme 10), wherein the layer containing the compound is a hole transport layer, a hole injection layer, an electron transport layer, an electron injection layer or a light emitting layer.

12) The organic light emitting devise according to item 10), wherein the layer containing the compound is a hole transport layer.

13) The organic light emitting devise according to item 12), wherein the compound comprises at least one primary, secondary or tertiary amine moiety.

14) The organic light emitting devise according to item 12), wherein the compound is a π-electron-rich condensed or uncondensed aromatic heterocyclic compound having at least two asymmetric carbon atoms per a molecule.

15) The organic light emitting device according to item 10), wherein the layer containing the compound is an electron transport layer.

16) The organic light emitting devise according to item 15), wherein the compound is an electron-deficient aromatic heterocyclic compound having at least two asymmetric carbon atoms per a molecule.

17) The organic light emitting device according to item 14), wherein the π-electron-rich condensed or uncondensed aromatic heterocyclic compound is a 5-membered aromatic heterocyclic compound containing one hetero atom in their rings each, a compound formed by fusing two of them together, or a compound formed by fusing two of them together, or a compound formed by fusing one of them and one or more of aromatic hydrocarbon rings

18) The organic light emitting devise according to item 14), wherein the π-electron-rich condensed or uncondensed aromatic heterocyclic compound is a pyrrole, a thiophene, a furan, an indole, a carbazole, a benzothiophene, a benzofuran, a dibenzothiophene, a dibenzofuran or an indolizine.

19) The organic light emitting devise according to item 10), wherein the compound has at least two substituent group containing asymmetric carbon atoms.

20) The organic light emitting device according to item 19), wherein the substituents group is a sec-butyl group, a 2-ethylhexyl group, an α-substituted benzyl group, or a group derived from an amino acid.

21) A primary, secondary or tertiary amine compound comprising at least two asymmetric carbon atoms per a molecule.

22) A condensed or uncondensed π-electron-rich aromatic heterocyclic compound having at least two asymmetric carbon atoms per a molecule.

23) An electron-deficient aromatic heterocyclic compound having at least two asymmetric carbon atoms per a molecule.

24) The electron-deficient aromatic heterocyclic compound according to item 23), which comprises at least one condensed or uncondensed aromatic 5-membered heterocyclic ring in which at least two hetero atoms including at least one nitrogen atom are contained.

25) An electron-deficient aromatic heterocyclic compound according to claim 23, which comprises at least one condensed or uncondensed nitrogen-containing aromatic 6-membered heterocyclic ring.

### DETAILED DESCRIPTION OF THE INVENTION

The compounds relating to the invention are described below.

The present compounds have a structure that at least two substituent groups which each contain an asymmetric carbon atom are attached to an electron-rich hole-transporting compound, or a structure that at least two substituent groups which each contain an asymmetric carbon atom are attached to an electron-transporting compound, representative examples of which include electron-deficient heterocyclic compounds.

Therefore, the present organic light-emitting device material refers preferably a hole transport material or electron transport material.

The skeletons of hole-transporting compounds are illustrated first.

As groups having hole-transporting capability, those derived from compounds having various structures are known in the art. First of all, such compounds include amine derivatives, namely compounds having primary, secondary and tertiary nitrogen atoms respectively Of these amine derivatives, amines containing as substituents aryl or aromatic heterocyclic groups are preferred over others. In particular, the tertiary amine compounds all the substituents of which are aryl or aromatic heterocyclic groups are advantageous.

Secondly, π-electron-rich aromatic heterocyclic compounds can be included in the hole-transporting compounds. The term “π-electron-rich aromatic heterocyclic compound” as used herein refers to the compound having an aromatic hetero ring wherein the number of π-electrons is greater than that of the ring-constituting atoms. Specifically, such a compound includes 5-membered aromatic heterocyclic compounds containing one hetero atom in their rings each, compounds formed by fusing two of them together, and compounds formed by fusing one of them and one or more of aromatic hydrocarbon rings. As examples of those aromatic heterocyclic compounds, mention may be made of pyrrole, thiophene, furan, indole, carbazole, benzothiophene, benzofuran, dibenzothiophene, dibenzofuran and indolizine.

Other nitrogen-containing compounds from which usable hole-transporting groups are derived can include hydrazone compounds, pyrazolone compounds, hydroxylamine compounds and alkoxyamine compounds.

The skeletons of electron-transporting compounds are illustrated next.

As groups having electron-transporting capability, those derived from compounds having various structures are known in the art. In particular, the groups derived from aromatic heterocyclic rings can be employed as effective ones. The aromatic heterocyclic rings coming under one useful class are aromatic 5-membered heterocyclic compounds which each contain at least two hetero atoms including at least one nitrogen atom. As examples of such compounds, mention may be made of pyrazole, imidazole, oxazole, thiazole, triazole (including 1,2,3- and 1,2,4-triazoles), tetrazole, oxadiazole (including 1,2,4-, 1,2,5- and 1,3,4-oxadiazoles) and thiadiazole (including 1,2,4-, 1,2,5- and 1,3,4-thiadiazoles). In addition to these compounds, the compounds formed by fusing any two or more of those rings together and those formed by fusing any one of those rings and an aromatic hydrocarbon may be included in the foregoing class.

The aromatic ring compounds coming under another useful class are electron-deficient nitrogen-containing 6-membered aromatic heterocyclic compounds. As examples of such 6-membered heterocyclic compounds, mention may be made of pyridine, pyridazine, pyrimidine, pyrazine and triazine. As to the compounds of this class also, compounds formed by fusing any two or more of those rings together and those formed by any one of those rings and an aromatic hydrocarbon or an aromatic 5- or 6-membered heterocyclic ring are usable likewise. For instance, quinazoline and quinoxaline can be included therein Further, complex compounds formed by coordination of heterocyclic compounds as recited above to metallic atoms or ions can be cited as other usable examples. To be concrete, these complex compounds can include a compound in which coordinate bonds are formed between a central metallic atom and lone-pair electrons of hetero atoms contained in aromatic heterocyclic rings or anionic substituents attached thereto (with examples including Alq derivatives mentioned above), a compound in which coordinate bonds are formed between a central metallic atom and n-electrons of aromatic heterocyclic or hydrocarbon rings (with examples including metallocenes), and an orthometalated complex formed by direct binding of a metal to an aromatic heterocyclic or hydrocarbon ring.

Furthermore, silole derivatives can be cited as examples of an electron transporting heterocyclic compound having only one hetero atom.

Then, substituent groups having asymmetric carbon atoms are illustrated.

The presence of substituent groups having asymmetric carbon atoms is a distinctive characteristic of the present compounds. The term asymmetric carbon atom is one of basic concepts known in the field of organic chemistry, and refers to the carbon atom whose four bonding hands formed of valence electrons in sp³ hybrid orbitals are linked with groups or atoms different from each other. The compounds used in the invention are compounds which each have at least two substituent groups containing asymmetric carbon atoms. Examples of such an asymmetric carbon-containing substituent group include a sec-butyl group, a 2-ethylhexyl group, an (x-substituted benzyl group, groups derived from amino acids, such as glycine and alanine, and substitutent groups of natural origin. In particular, it is beneficial to the invention that these groups are in a racemic state as a mixture of R and S.

In addition to asymmetric carbon-containing substituent groups, the hydrogen atoms of the present compounds may be replaced with various substituents. Examples thereof include a halogen atom (e.g., fluorine, chlorine, bromine, iodine), a cyano group, a formyl group, a substituted or unsubstituted alkyl group (containing preferably 1 to 30 carbon atoms, more preferably 1 to 15 carbon atoms, such as methyl, ethyl, t-butyl or cyclohexyl), an alkenyl group (containing preferably 2 to 30 carbon atoms, more preferably 2 to 15 carbon atoms, such as vinyl, 1-propenyl, 1-butene-2-yl or cyclohexene-1-yl), an alkynyl group (containing preferably 2 to 30 carbon atoms, more preferably 2 to 15 carbon atoms, such as ethynyl or 1-propynyl), an aryl group (containing preferably 6 to 30 carbon atoms, more preferably 6 to 15 carbon atoms, such as phenyl, tolyl, xylyl, naphthyl, biphenylyl or pyrenyl), a heterocyclic group (which is preferably a 5- or 6-membered ring, may be fused together with another ring, and contains nitrogen, oxygen or/and sulfur atom(s) as hetero atom(s) in addition to 2 to 30 carbon atoms, preferably 2 to 15 carbon atoms, with examples including pyridyl, piperidyl, oxazolyl, oxadiazolyl, tetrahydrofuryl, carbazolyl and thienyl), primary to tertiary amino groups (including amino, alkylamino, arylamino, dialkylamino, diarylamino, alkylarylamino, heterocyclic amino and bisheterocyclic amino groups, preferably tertiary amino groups containing preferably 1 to 30 carbon atoms, more preferably 1 to 16 carbon atoms, such as dimethylamino, diphenylamino and phenylnaphthylamino), an imino group (represented —CR₁₁═NR₁₂ —N═CR₁₃R₁₄ wherein R₁₁ to R₁₄ are each a hydrogen atom or a group selected from alkyl, aryl, heterocyclic, alkoxy, aryloxy, acyl or primary to tertiary amino groups, preferably containing 1 to 30 carbon atoms, more preferably containing 1 to 15 carbon atoms), an alkoxy group (containing preferably 1 to 30 carbon atoms, more preferably 1 to 15 carbon atoms, such as methoxy, ethoxy or cyclohexyloxy), an aryloxy group (including a heteroaryloxy group also, wherein is contained preferably 6 to 30 carbon atoms, more preferably 6 to 15 carbon atoms, such as phenoxy, 1-naphthoxy or 4-phenylphenoxy), an alkylthio group (containing preferably 1 to 30 carbon atoms, more preferably 1 to 15 carbon atoms, such as methylthio, ethylthio or cyclohexylthio), an arylthio group (including a heteroarylthio group also, wherein is contained preferably 6 to 30 carbon atoms, more preferably 6 to 15 carbon atoms, such as phenylthio or tolylthio), a carbonamido group (containing preferably 1 to 30 carbon atoms, more preferably 1 to 15 carbon atoms, such as acetamido, benzoylamido or N-methylbenzoylamido), a sulfonamido group (containing preferably 1 to 30 carbon atoms, more preferably 1 to 15 carbon atoms, such as methanesulfonamido, benzenesulfonamido or p-toluenesulfonamido), a carbamoyl group (containing preferably 1 to 30 carbon atoms, more preferably 1 to 15 carbon atoms, such as unsubstituted carbamoyl, methylcarbamoyl, dimethylcarbamoyl, phenylcarbamoyl, diphenylcarbamoyl or dioctylcarbamoyl), a sulfamoyl group (containing preferably 1 to 30 carbon atoms, more preferably 1 to 15 carbon atoms, such as unsubstituted sulfamoyl, methylsulfamoyl, dimethylsulfamoyl, phenylsulfamoyl, diphenylsulfamoyl or dioctylsulfamoyl), an alkylcarbonyl group (containing preferably 2 to 30 carbon atoms, more preferably 2 to 15 carbon atoms, such as acetyl, propionyl, butyroyl or lauroyl), an arylcarbonyl group (including a heteroarylcarbonyl group also, wherein is contained preferably 7 to 30 carbon atoms, more preferably 7 to 15 carbon atoms, such as benzoyl or naphthoyl), an alkylsulfonyl group (containing preferably 1 to 30 carbon atoms, more preferably 1 to 15 carbon atoms, such as methanesulfonyl or ethanesulfonyl), an arylsulfonyl group (including a heteroarylsulfonyl group also, wherein is contained preferably 6 to 30 carbon atoms, more preferably 6 to 15 carbon atoms, such as benzenesulfonyl, p-toluenesulfonyl or 1-naphthalenesulfonyl), an alkoxycarbonyl group (containing preferably 2 to 30 carbon atoms, more preferably 2 to 15 carbon atoms, such as methoxycarbonyl, ethoxycarbonyl or butoxycarbonyl), an aryloxycarbonyl group (including a heteroaryloxycarbonyl group also, wherein is contained preferably 7 to 30 carbon atoms, more preferably 7 to 15 carbon atoms, such as phenoxycarbonyl or 1-naphthoxycarbonyl), an alkylcarbonyloxy group (containing preferably 2 to 30 carbon atoms, more preferably 2 to 15 carbon atoms, such as acetoxy, propionyloxy or butyroyloxy), an arylcarbonyloxy group (including a heteroarylcarbonyloxy group also, wherein is contained preferably 7 to 30 carbon atoms, more preferably 7 to 15 carbon atoms, such as benzoyloxy or 1-naphthoyloxy), an urethane group (containing preferably 2 to 30 carbon atoms, more preferably 2 to 15 carbon atoms, such as methoxycarbonamido, phenoxycarbonamido or methylaminocarbonamido), an ureido group (containing preferably 1 to 30 carbon atoms, more preferably 1 to 15 carbon atoms, such as methylaminocarbonamido, dimethylaminocarbonamido or diphenylaminocarbonamido), and a carboxylate group (containing preferably 2 to 30 carbon atoms, more preferably 2 to 15 carbon atoms, such as methoxycarbonyloxy or phenoxycarbonyloxy).

Further, the present compounds each may be a low molecular compound, or may constitute groups attached to the main polymeric chain of a high molecular compound (having a weight average molecular weight (Mw) of 1,000 to 5,000,000, preferably 5,000 to 1,000,00, particularly preferably 10,000 to 1,000,000), or may constitute the main polymeric chain of a high molecular compound (having a weight average molecular weight (Mw) of 1,000 to 5,000,000, preferably 5,000 to 1,000,00, particularly preferably 10,000 to 1,000,000). When the high molecular compounds are constituted of the present compounds, they may be homopolymers or copolymers. Such copolymers may be random copolymers or block copolymers. However, it is advantageous that the present compounds be low molecular compounds having a molecular weight of 10,000 or below, particularly 2,000 or below. The suitable lower limit for molecular weight of the present compounds is 100, preferably 300.

When the present compounds have final structures capable of performing their function, it is possible to use them as they are whether their molecular weight is low or high. On the other hand, it is also possible to use precursors of the present compounds irrespective of molecular weight in organic electric-field luminescent devices and lead them so as to have the final structures by physical or chemical after-treatment during or after the device formation.

The present compounds can be synthesized by known methods. Examples of basic skeletons the present compounds can generally have and suitable examples of the present compounds are illustrated below. Subsequently thereto, the synthesis scheme for an exemplary of the present compounds is disclosed. However, these examples should not be construed as limiting the scope of the invention.

The basic skeletons the present hole-transporting compounds can have are illustrated below:

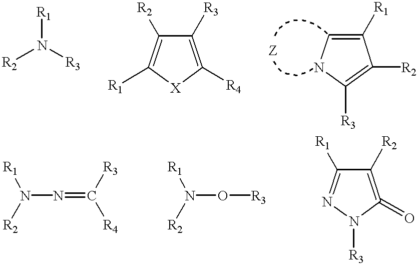

In the above structural formulae, X represents —O—, —S— —N(R₅)—. Z represents an atomic group forming a ring including a heterocyclic ring. The ring formed by Z is preferably an aromatic 5- or 6-membered heterocyclic ring or a condensed heterocyclic ring capable of having pseudo-aromaticity in its entirety. Each of R₁ to R₅ represents a hydrogen atom, a halogen atom, an alkyl group, an aryl group, a heterocyclic group, an alkoxy group, an aryloxy group (including a heteroaryloxy group), an alkylthio group, an arylthio group (including heteroarylthio group), a primary, secondary or tertiary amino group, acarbamoyl group, a sulfamoyl group, a carbonamido group, a sulfonamido group, an acyl group, an alkoxycarbonyl group, an aryloxycarbonyl group (including a heteroaryloxycarbonyl group), an acyloxy group, an urethane group, an ureido group, or a carboxylate group. Any adjacent two among the substituents R₁ to R₅ in the above structural formulae may combine with each other to form a ring. The present compounds are each required to contain a total of at least two asymmetric carbon atoms in any of the substituents R₁ to R₆ or/and the ring formed by Z.

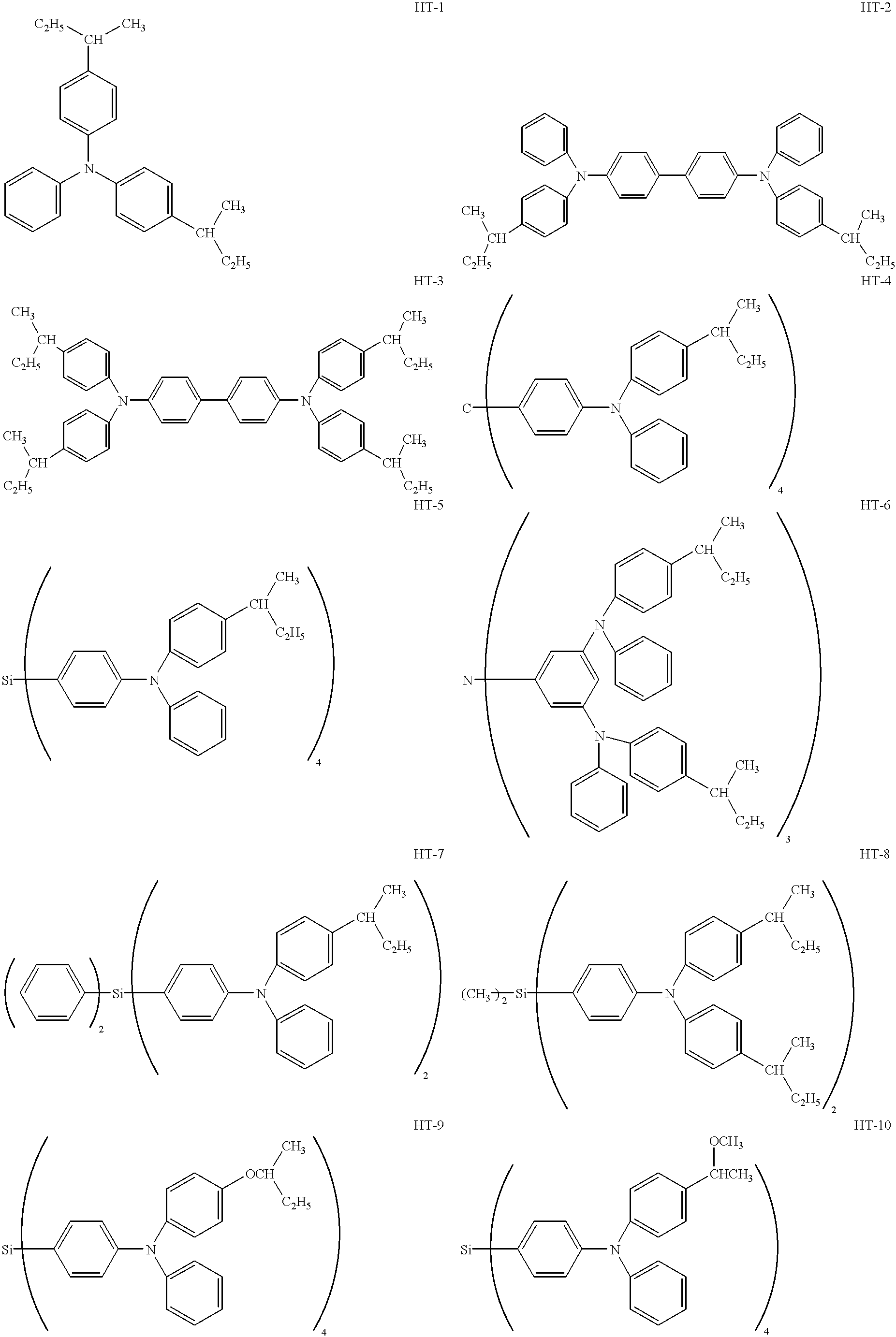

The synthesis route to Compound HT-2 is illustrated below:

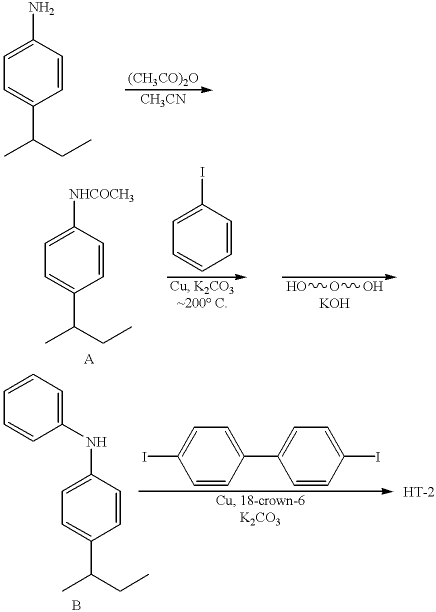

### Synthesis of Compound HT-2

Synthesis of Compound A:

p-sec-Butylaniline in an amount of 149.2 g (1.0 mole) was dissolved in 600 ml of acetonitrile with stirring to prepare a homogenous solution. Thereto, 104 g (1.02 moles) of acetic anhydride was added dropwise over a 30-minute period with stirring at room temperature, resulting in a rise in the internal temperature to 50° C. The resulting mixture was kept stirring as it was. When the internal temperature was lowered to about 35° C., crystals were deposited. After cooling to room temperature, the contents were poured into 5,000 ml of cold water; as a result, crystals separated out. These crystals were filtered off, and recrystallized from a mixed solvent of acetonitrile and water to yield 183 g of crystalline Compound A.

Synthesis of Compound B:

In a 1000 ml three-necked flask were placed 115 g (0.6 mole) of Compound A, 166 g (1.2 moles) of anhydrous potassium carbonate and 3 g of copper powder. The contents were stirred while increasing the external temperature to 200° C. Under these conditions, the stirring was further continued for 24 hours. Thereafter, the internal temperature of the flask was lowered to 70° C. Thereto, 400 ml of ethylacetate was added, and refluxed with stirring for one hour. Thereafter, the contents were filtered through a Nutsche funnel under reduced pressure as they were hot. The filtrate obtained was concentrated with a rotary evaporator. To the resulting residue, 500 ml of diethylene glycol and 105 g (1.8 moles) of potassium hydroxide were added, and the reaction was continued for 1 hour in a stream of nitrogen as the external temperature was kept at 200° C. This reaction solution was poured into a cold aqueous solution of hydrochloric acid, and thereby an oily matter separated out. This oily matter was gathered, dried, and then purified by column chromatography on silica gel. Thus, 106 g of Compound B was obtained.

Synthesis of Compound ET-18

In a 1,000 ml three-necked flask were placed 113 g (0.5 mole) of Compound B, 81.2 g (0.2 mole) of 4,4′-diiodobiphenyl, 138 g (1.0 mole) of anhydrous potassium carbonate, 5 g of copper powder and 10 g of 18-crown-6-ether. The contents were stirred while increasing the external temperature to 200° C. Under these conditions, the stirring was continued for additional 24 hours. Thereafter, the internal temperature of the flask was lowered to 70° C. Thereto, 400 ml of ethylacetate was added, and refluxed with stirring for one hour. Then, the contents were filtered through a Nutsche funnel under reduced pressure as they were hot. The filtrate obtained was concentrated with a rotary evaporator. The thus obtained oily matter was purified by column chromatography on silica gel to yield 96 g of crystalline Compound HT-2.

The basic skeletons the present electron-transporting compounds can have are illustrated below:

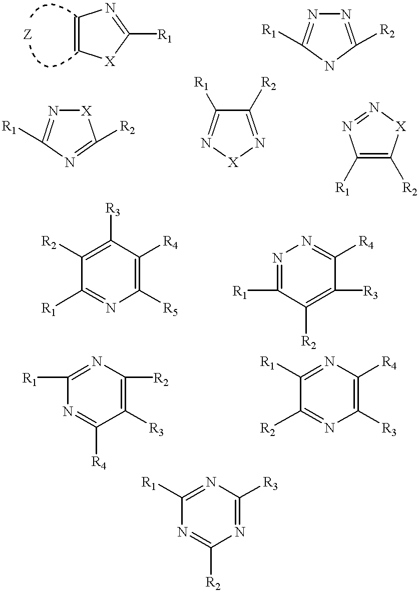

In the above structural formulae, X represents —O—, —S— or —N (R₆)—. Z represents a mere double bond, or an atomic group forming a ring including a heterocyclic ring. The ring formed by Z is preferably an aromatic hydrocarbon ring or an aromatic 5-or 6-membered heterocyclic ring. Each of R₁ to R6 represents a hydrogen atom, a halogen atom, an alkyl group, an aryl group, a heterocyclic group, an alkoxy group, an aryloxy group (including a heteroaryloxy group), an alkylthio group, an arylthio group (including heteroarylthio group), a primary, secondary or tertiary amino group, acarbamoyl group, a sulfamoyl group, a carbonamido group, a sulfonamido group, an acyl group, an alkoxycarbonyl group, an aryloxycarbonyl group (including a heteroaryloxycarbonyl group), an acyloxy group, an urethane group, an ureido group, or a carboxylate group. Any adjacent two among the substituents R₁ to R₆ in the above structural formulae may combine with each other to form a ring. The present compounds are each required to contain a total of at least two asymmetric carbon atoms in any of the substituents R₁ to R₆ or/and the ring formed by Z.

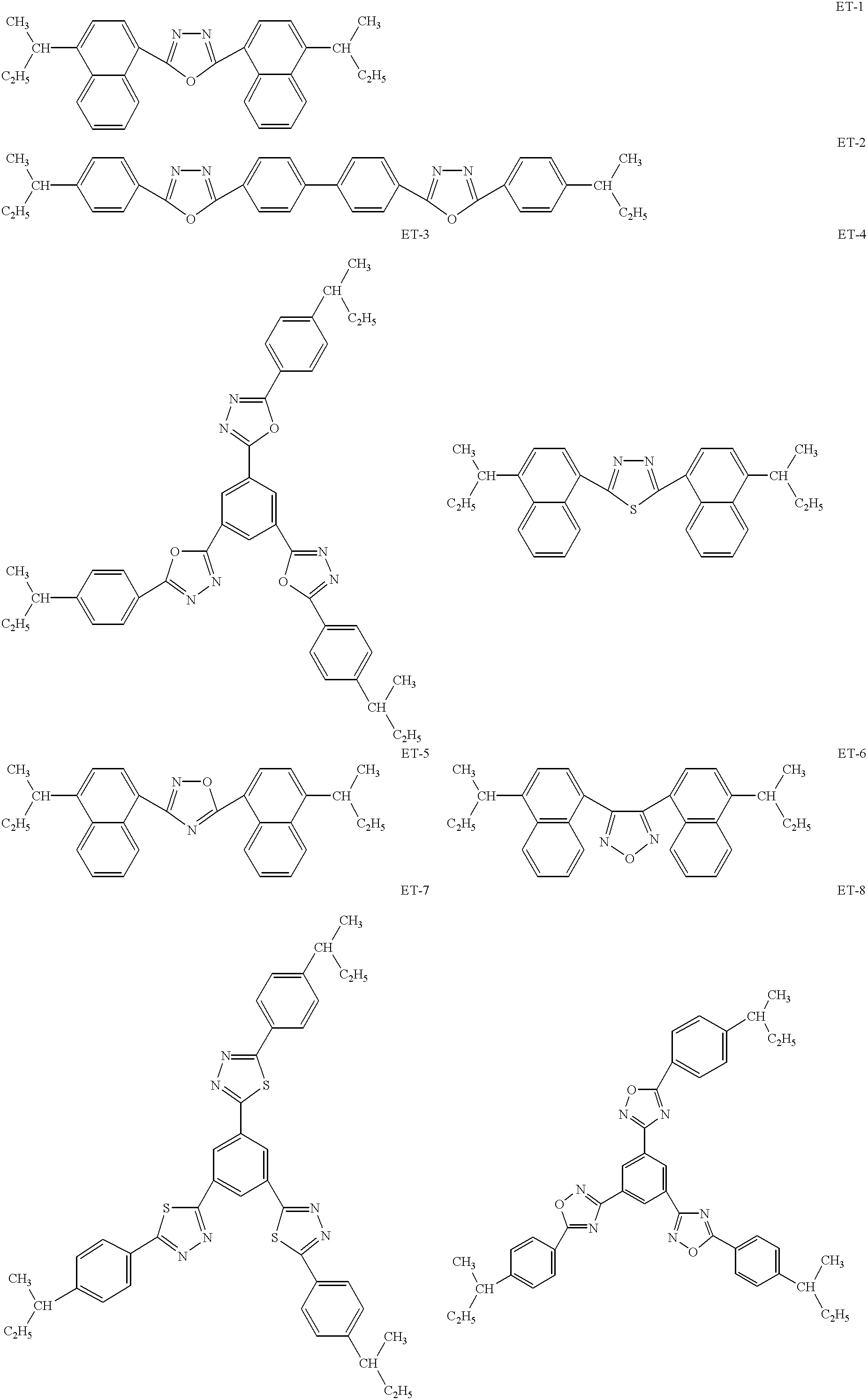

The synthesis route to Compound ET-18 is illustrated below:

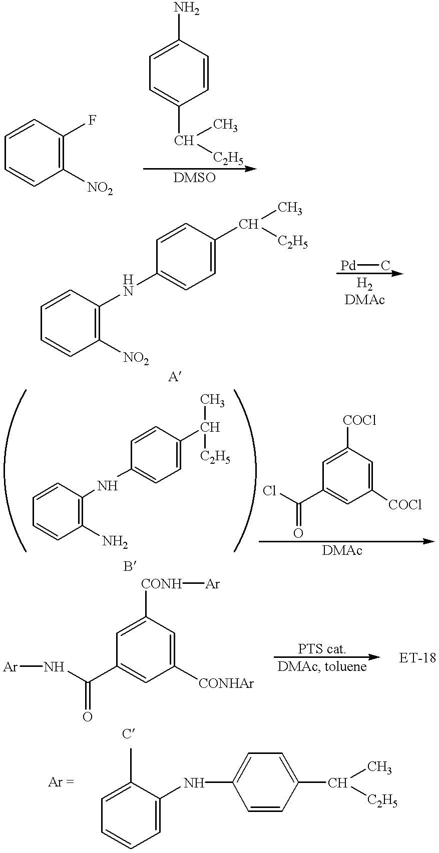

### Synthesis of Compound ET-18

Synthesis of Compound A′

o-Nitrofluorobenzene in an amount of 28.2 g (0.2 mole) was dissolved in 100 ml of dimethyl sulfoxide (DMSO) with stirring. Thereto, 32.8 g (0.22 mole) of p-sec-butylaniline was added, and heated up to 150° C. with stirring on an oil bath. Under these conditions, the reaction was continued for 4 hours. At the conclusion of the reaction the contents were poured into a cold aqueous solution of ammonium chloride; as a result, an oily compound separated out. After the supernatant was decanted, the residual oil was admixed with ethyl acetate and water, and underwent the separation procedure with a separatory funnel. The ethyl acetate phase was dried over anhydrous magnesium sulfate, and then the solvent was distilled away under reduced pressure. The oil obtained was purified by column chromatography on silica gel. Thus, 46.5 g of Compound A′ was obtained.

Synthesis of Compound C′ from Compound A′ via Compound B′

Compound A′ in an amount of 35.1 g (0.13 mole) was dissolved in 150 ml of N,N-dimethylacetamide (DMAc). This solution was poured into an autoclave having an internal volume of 1,000 ml, made by Nitto Koatsu Co., Ltd. To this solution was added 3 g of 5% Pd-C catalyst, and 10 Mpa of hydrogen gas was charged into the autoclave. Then, the contents in the autoclave were stirred by electromagnetic force to react with each other for 3 hours as the internal temperature was controlled to 40-50° C. At the conclusion of the reaction the hydrogen gas was removed, and the interior of the autoclave was purged with nitrogen gas. Thereafter, the contents were taken out of the autoclave, and filtered through a Nutsche funnel paved with cerite under reduced pressure. In addition, the washing obtained by cleaning the interior of the autoclave with 50 ml of DMAc was also filtered in the same manner as described above. By these procedures, the catalyst was removed from the solutions. The combined filtrates were transferred into a 1,000 ml three-necked flask equipped with a thermometer and a stirrer, and thereto 7.96 g (0.03 mole) of 1,3,5-benzenetricarbonyl chloride was added little by little with stirring. Since the internal temperature rose by reaction, a water bath was used with care so as not to raise the internal temperature beyond 25° C. during the reaction. After the addition was completed, the stirring was further continued at room temperature. In the meantime crystals began to separate out. The stirring was continued for additional 3 hours at room temperature without changing the conditions. Thereafter, the contents were poured into cold water, and thereby crystals separated out. These crystals were filtered off and washed with water. These crude crystals were further washed with hot acetonitrile, filtered off, and dried to yield 20 g of crystalline Compound C′.

Synthesis of Compound ET-18

Compound C′ in an amount of 17.5 g (0.02 mole) was added to a mixed solvent consisting of 60 ml of DMAc and 60 ml of toluene, and thereto 2 g of p-toluenesulfonic acid monohydrate was further added. The reaction vessel was fitted with a condenser coupled to a Dean-Stark water separator, and the mixture was refluxed with stirring for 6 hours over an oil bath. After the conclusion of the reaction, the reaction mixture was cooled, and thereby crystals separated out. These crystals were filtered off, washed with water and dried. The crude crystals obtained were purified by column chromatography on silica gel to yield 9.5 g of crystalline Compound ET-18.

Next, light emitting devices containing the present compounds are illustrated. The organic layers of the light emitting devices containing the present compounds are not particularly restricted as to their formation methods, but they can be formed using various methods. For instance, a resistance heating vapor deposition method, an electron-beam method, a sputtering method, a molecular lamination method, a coating method, a printing method and an ink-jet method can be adopted. Of these methods, the resistance heating vapor deposition method and the coating method are preferred over the others in the characteristic and productive aspects.

Every light emitting device according to the invention is a device comprising a pair of electrodes, namely an anode and a cathode, between which a light emitting layer or at least two thin layers of organic compounds, inclusive of a light emitting layer, are sandwiched. The organic thin layers the device may have in addition to the light emitting layer are, e.g., a hole injection layer, a hole transport layer, an electron injection layer, an electron transport layer and a protective layer. Each of these layers may have another function. For forming each layer, various materials can be employed.

The anode supplies holes to a hole injection layer, a hole transport layer and a light emitting layer. It can be made of a metal, an alloy, a metal oxide, an electrically conductive material or a mixture of two or more thereof, preferably a material having a work function of at least 4 eV. Examples of such a material include conductive metal oxides, such as tin oxide, zinc oxide, indium oxide and indium tin oxide (ITO),metals such as gold, silver, chromium and nickel, mixtures or laminates of those metals and conductive metal oxides, inorganic conductive materials such as copper iodide and copper sulfide, organic conductive materials such as polyaniline, polythiophene and polypyrrole, and laminates of those materials and ITO. Of the materials recited above, the conductive metal oxides, especially ITO, are advantageous over the others from the viewpoints of productivity, high conductivity and transparency. The suitable thickness of the anode, though can be chosen depending on the anode material, is generally from 10 nm to 5 μm, preferably 50 nm to 1 μm, particularly preferably 100 nm to 500 nm.

In general the anode is used in the state of a layer formed on a soda lime glass, alkali-free glass or transparent resin substrate. In the case of using a glass substrate, alkali-free glass is preferred from the viewpoint of reduction in ions eluted from the glass. When soda lime glass is used as the substrate, it is favorable that the glass be provided with a barrier coating, such as a silica coating. The substrate thickness has no particular limitation so long as the substrate can ensure mechanical strength for the anode. For instance, the suitable thickness of a glass substrate is at least 0.2 mm, preferably at least 0.7 mm. The methods suitable for making the anode vary with the material used. In the case of ITO, for instance, the film formation can be carried out using an electron beam method, a sputtering method, a resistance heating vapor deposition method, a chemical reaction method (e.g., sol-gel method) or the method of coating a dispersion of indium tin oxide. By receiving washing and other treatments after film formation, the anode can yield in the device a reduction of operation potential and elevation of light-emitting efficiency. In the case of an anode using ITO, it is effective for the anode to receive UV-ozone treatment or plasma treatment.

The cathode supplies electrons to an electron injection layer, an electron transport layer and a light emitting layer. In selecting the cathode, the adhesion to the layer adjacent to the cathode, e.g., an electron injection, electron transport or light emitting layer, the ionization potential and the stability are taken into consideration. As cathode materials, metals, alloys, metal halides, metal oxides, electrically conductive materials and mixtures of two or more thereof can be employed. Examples of such materials include alkali metals (e.g., Li, Na, K, Cs) and the fluorides or oxides thereof, alkaline earth metals (e.g., Mg, Ca) and the fluorides or oxides thereof, gold, silver, lead, aluminum, Na-K alloy or mixture, Li-Al alloy or mixture, Mg-Ag alloy or mixture, and rare earth metals (e.g., In, Yb). Of these materials, the materials having a work function of at most 4 eV are preferred over the others. In particular, aluminum, Li-Al alloy or mixture, and Mg-Ag alloy or mixture are used to advantage. The cathode may have not only a single-layer structure formed of a compound or a mixture as recited above but also a lamination structure comprising a compound and a mixture as recited above. The suitable thickness of the cathode, though can be chosen depending on the cathode material, is generally from 10 nm to 5 μm, preferably 50 nm to 1 μm, particularly preferably 100 nm to 1 μm. In forming the cathode, various known methods, such as an electron beam method, a sputtering method, a resistance heating vapor deposition method and a coating method, can be adopted. The metals as recited above may be evaporated independently, or two or more thereof maybe evaporated simultaneously. Further, it is possible to evaporate a plurality of metals at the same time to form an alloy electrode. Also, the previously prepared alloy may be subjected to vapor deposition. It is advantageous to the light emitting device that both anode and cathode have low sheet resistance, specifically several hundreds Q/FL at the highest.

For constituting a light emitting layer, any materials can be used as far as they can form a layer having the following functions. One function is to receive hole injection from the anode, the hole injection layer or the hole transport layer as well as electron injection from the cathode, the electron injection layer or the electron transport layer when the electric field is applied to the light emitting device. Another function is to permit the charges injected in the layer to move. The other function is to enable the emission of light by providing a place for recombining holes and electrons. Examples of such materials include benzoxazole derivatives, benzimidazole derivatives, benzothiazole derivatives, styrylbenzene derivatives, polyphenyl derivatives, diphenylbutadiene derivatives, tetraphenylbutadiene derivatives, naphthalimide derivatives, coumarin derivatives, perylene derivatives, perinone derivatives, oxadiazole derivatives, aldazine derivatives, pyraridine derivatives, cyclopentadiene derivatives, bisstyrylanthracene derivatives, quinacridone derivatives, pyrrolopyridine derivatives, thiadiazolopyridine derivatives, styrylamine derivatives, aromatic dimethylidyne compounds, various metal complexes represented by metal or rare earth complexes of 8-quinolinol derivatives and orthometalated complexes, polymeric compounds such as polythiophene, polyphenylene and polyphenylenevinylene, and compounds according to the invention. Although the light emitting layer has no particular restrictions as to the thickness, the suitable thickness thereof is generally from 1 nm to 5 μm, preferably 5 nm to 1 μm, particularly preferably 10 nm to 500 nm.

As to the method of forming the light emitting layer, there is no particular restriction, but various methods can be adopted. Examples of methods usable herein include a resistance heating vapor deposition method, an electron beam method, a sputtering method, a molecular lamination method, a coating method (e.g., a spin coating, cast coating or dip coating method), an LB method, a printing method and an ink-jet method. Of these methods, a resistance heating vapor deposition method and a coating method are preferred over the others.

The materials for a hole injection layer and a hole transport layer may be any materials as long as they have any one of the functions as an injector of holes from the anode, a transporter of holes and a barrier against electrons injected from the cathode. Examples of a material having one of such functions include carbazole derivatives, triazole derivatives, oxazole derivatives, oxadiazole derivatives, imidazole derivatives, polyarylalkane derivatives, pyrazoline derivatives, pyrazolone derivatives, phenylenediamine derivatives, arylamine derivatives, amino-substituted chalcone derivatives, styrylanthracene derivatives, fluorenone derivatives, hydrazone derivatives, stilbene derivatives, silazane derivatives, aromatic tertiary amine compounds, styrylamine compounds, aromatic dimethylidyne compounds, porphyrin compounds, polysilane compounds and conductive polymers and oligomers such as poly(N-vinylcarbazole) derivatives, aniline copolymers, thiophene oligomers and polythiophene, and amine part- or π-electron-rich aromatic heterocyclic nucleus-containing compounds according to the invention. The suitable thickness of the hole injection layer and the hole transport layer each, though it has no particular limitation, is generally from 1 nm to 5 μm, preferably 5 nm to 1 μm, particularly preferably 10 nm to 500 nm. Each of the hole injection layer and the hole transport layer may have a single-layer structure constituted of one or more of the materials recited above or a multiple-layer structure made up of at least two layers having the same composition or different compositions.

As a method of forming the hole injection layer and the hole transport layer, a vacuum evaporation method, an LB method, an ink-jet method, a method of coating a solution or dispersion of hole-injecting and transporting agents (e.g., a spin coating, cast coating or dip coating method) or a printing method can be adopted. When the coating method is adopted, the material(s) to constitute such a layer may be dissolved or dispersed in a coating solvent together with a resinous ingredient. Examples of such a resinous ingredient include polyvinyl chloride, polycarbonate, polystyrene, polymethylmethacrylate, polybutylmethacrylate, polyester, polysulfone, polyphenylene oxide, polybutadiene, poly(N-vinylcarbazole), hydrocarbon resin, ketone resin, phenoxy resin, polyamide, ethyl cellulose, polyvinyl acetate, ABS resin, polyurethane, melamine resin, unsaturated polyester resin, alkyd resin, epoxy resin and silicone resin.

The materials for the electron injection layer and the electron transport layer may be any materials so long as they have any one of the functions as an injector of electrons from the cathode, a transporter of the electrons and a barrier against holes injected from the anode, but the electron-deficient aromatic heterocyclic compounds according to the invention are preferred as such materials. The suitable thickness of the electron injection layer and the electron transport layer each, though it has no particular limitation, is generally from 1 nm to 5 μm, preferably 5 nm to 1 μm, particularly preferably 10 nm to 500 nm. Each of the electron injection layer and the electron transport layer may have a single-layer structure constituted of one or more of the materials as mentioned above, or a multiple-layer structure made up of at least two layers having the same composition or different compositions comprising one or more of the materials as mentioned above.

As a method of forming the electron injection layer and the electron transport layer each, a vacuum evaporation method, an LB method, an ink-jet method, a method of coating a solution or dispersion of electron-injecting or transporting agent as mentioned above (e.g., a spin coating, cast coating or dip coating method) or a printing method can be adopted. In the case of adopting a coating method, the electron-injecting and transporting agents each can be dissolved or dispersed together with a resinous ingredient. Examples of a resinous ingredient usable therein include the same resins as employed for the hole injection and transport layers.

The protective layer may be made up of any of materials so long as they can function as an agent of inhibiting deterioration promoters, such as moisture and oxygen, from invading into the device. Examples of such a material include metals such as In, Sn, Pb, Au, Cu, Ag, Al, Ti and Ni, metal oxides such as MgO, SiO, SiO₂, Al₂O₃, GeO, NiO, CaO, BaO, Fe₂O₃, Y₂O₃ and TiO₂, metal fluorides such as MgF₂, LiF, AlF₃ and CaF₂, polyethylene, polypropylene, polymethyl methacrylate, polyimide, polyurea, polytetrafluoroethylene, polychloro-trifluoroethylene, polydichlorodifluoroethylene, copolymer of chlorotrifluoroethylene and dichlorodifluoroethylene, a copolymer prepared by polymerizing a mixture of tetrafluoroethylene and at least one comonomer, and a fluorine-containing copolymer having cyclic structures in the main chain, a water-absorbing substance having a water absorption rate of at least 1 %, and a moisture-proof substance having a water absorption rate of at most 0.1 %.

The protective layer also has no particular restriction as to its formation method, but any of a vacuum evaporation method, a sputtering method, a reactive sputtering method, a molecular beam epitaxy (MBE) method, a cluster ion beam method, an ion plating method, a plasma polymerization method (high frequency excitation ion plating method), a plasma chemical vapor deposition (CVD) method, a laser CVD method, a heat CVD method, a gas source CVD method, a coating method, an ink jet method and a printing method can be adopted for the formation thereof.

The invention will now be illustrated in more detail by reference to the following examples. However, these examples should not be construed as limiting the scope of the invention in any way.

### EXAMPLE 1

A transparent substrate was prepared by forming a 150 nm-thick ITO film on a glass support whose dimensions were 25 mm by 25 mm by 0.7 mm (produced by Tokyo Sanyo Vacuum Industries Co., Ltd.), and then etched and followed by washing. Onto this substrate, copper phthalocyanine was evaporated in a film having a thickness of about 10 nm. Onto the substrate thus processed, about 40 nm-thick film of N,N′-bis(3-methylphenyl)-N,N′-diphenyl-benzidine (TPD) and about 60 nm-thick film of tris(8-hydroxyquinolinato)aluminum (Alq) as the third layer were evaporated in order of description under a condition that the pressure inside the vacuum evaporation apparatus was reduced to 10⁻³ to 10⁻⁴ Pa and the substrate temperature was kept at ambient temperature. On the thus formed laminate of organic compounds, a patterned mask (for adjusting each emission area to 5 mm×5 mm) was placed and further, inside the vacuum evaporation apparatus, Mg and Ag were evaporated simultaneously in a Mg/Ag ratio of 10/1 to form a metallic film having a thickness of 250 nm, followed by evaporation of a 300 nm-thick Ag film. Thus, an EL device No. 101 (a comparative sample) was made.

Then, EL devices Nos. 102 to 110 were further made in the same manner as the EL device No. 101, except that three different compounds for comparison and six different compounds according to the invention were used respectively in place of TPD.

Each of the thus made EL devices was made to luminesce by applying thereto a DC constant voltage by means of a source measure unit, Model 2400, made by Toyo Technica Co., Ltd., and examined for luminance and wavelength of light emission by using a luminometer BM-8 made by Topcon Co. and a spectrum analyzer PMA-11 made by Hamamatsu Photonics Co., respectively. The results obtained are shown in Table 1.

TABLE 1

| | | | Luminance |
|---|---|---|---|
| | Hole | Wavelength of | under applied |
| | transport | light emission | voltage of 10 V |
| Device No. | material | λmax (nm) | (cd/m²) |
| 101 (comparative) | TPD | 525 | 5600 |
| 102 (comparative) | A | 522 | 5300 |
| 103 (comparative) | B | 526 | 5450 |
| 104 (comparative) | C | 526 | 5550 |
| 105 (invention) | HT-2 | 525 | 5650 |
| 106 (invention) | HT-4 | 524 | 5700 |
| 107 (invention) | HT-5 | 525 | 5550 |
| 108 (invention) | HT-7 | 524 | 5550 |
| 109 (invention) | HT-11 | 524 | 5650 |
| 110 (invention) | HT-19 | 525 | 5700 |

Comparative Compound A

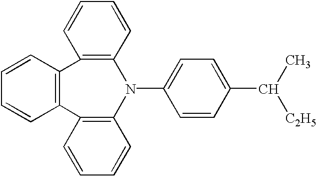

Comparative Compound B

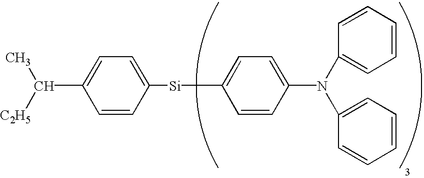

Comparative Compound C

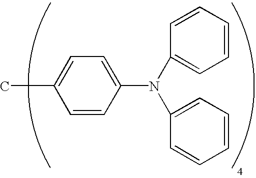

These devices were sealed up inside an autoclave filled with argon gas, and allowed to stand for 10 days as the inside temperature was kept at 85° C. by heating. Thereafter, the luminance measurement of each device was carried out in the same way as mentioned above, and the condition of the light emitting surface of each device was observed. The results obtained are shown in Table 2. Further, the operation of each device at a constant voltage of 10 V was continued for 100 hours in a glove box the inside air of which was in advance replaced by nitrogen gas, and examined again for luminance. From these measurement values, the proportion of each device's luminance retained after 100-hour continuous operation (to the initial luminance, expressed as percent) was calculated. These calculation results are shown in Table 3.

TABLE 2

| | Wavelength of | | Condition of |
|---|---|---|---|
| | light | Luminance under | light |
| | emission λmax | applied voltage | emitting |
| Device No. | (nm) | of 10 V (cd/m²) | surface^{*)} |
| 101 (comparison) | 523 | 1200 | bad |
| 102 (comparison) | 524 | 3500 | so-so |
| 103 (comparison) | 523 | 3800 | so-so |
| 104 (comparison) | 524 | 3850 | so-so |
| 105 (invention) | 524 | 5600 | good |
| 106 (invention) | 525 | 5650 | good |
| 107 (invention) | 524 | 5500 | good |
| 108 (invention) | 524 | 5450 | good |
| 109 (invention) | 526 | 5550 | good |
| 110 (invention) | 525 | 5600 | good |

^{*)}Evaluation by visual observation

TABLE 3

| | Proportion of luminance retained after |
|---|---|
| | continuous operation (to initial |
| Device No. | value), expressed as percent |
| 101 (comparison) | 37 |
| 102 (comparison) | 72 |
| 103 (comparison) | 69 |
| 104 (comparison) | 55 |
| 105 (invention) | 92 |
| 106 (invention) | 95 |
| 107 (invention) | 93 |
| 108 (invention) | 94 |
| 109 (invention) | 95 |
| 110 (invention) | 94 |

The results shown in Table 1 indicate that the device No. 101 and every other device were equivalent in luminance. However, as can be seen from the results shown in Tables 2 and 3, the present compound-using devices Nos. 105 to 110 were significantly superior to the devices Nos. 101 to 104 as typical comparative samples in durability to withstand not only the storage under high temperature conditions but also continuous operation under the testing condition mentioned above. These results prove clearly that the present compounds containing many asymmetric carbon atoms compared with the comparative compounds can achieve beneficial effects.

### EXAMPLE 2

On the ITO glass substrate etched and washed in the same manner as in Example 1 was spin-coated a solution prepared by dissolving 30 mg of polycarbonate and 30 mg of TPD in 3 ml of 1,2-dichloroethane. The thickness of the thus formed organic layer was about 60 nm. Then, Alq and the cathode were evaporated onto the organic layer in the same manner as in Example 1 to make an EL device No. 201.

Then, EL devices Nos. 202 to 205 were further made in the same manner as the EL device No. 201, except that two different compounds for comparison and two different compounds according to the invention were used respectively in place of TPD.

Each of the thus made EL devices was made to luminesce by applying thereto a DC constant voltage by means of a source measure unit, Model 2400, made by Toyo Technica Co., Ltd., and examined for luminance and wavelength of light emission by using a luminometer BM-8 made by Topcon Co. and a spectrum analyzer PMA-11 made by Hamamatsu Photonics Co., respectively. The results obtained are shown in Table 4.

TABLE 4

| | | | Luminance |
|---|---|---|---|
| | Electron | Wavelength of | under applied |
| | transport | light emission | voltage of 18 V |
| Device No. | material | λmax (nm) | (cd/m²) |
| 201 (comparative) | TPD | 521 | 2500 |
| 202 (comparative) | A | 520 | 2450 |
| 203 (comparative) | B | 522 | 2550 |
| 204 (invention) | HT-2 | 521 | 2600 |
| 205 (invention) | HT-5 | 522 | 2600 |

These devices were sealed up inside an autoclave filled with argon gas, and allowed to stand for 10 days as the inside temperature was kept at 85° C. by heating. Thereafter, the luminance measurement of each device was carried out in the same way as mentioned above, and the condition of the light emitting surface of each device was observed. The results obtained are shown in Table 5. Further, the operation of each device at a constant voltage of 10 V was continued for 100 hours in a glove box the inside air of which was in advance replaced by nitrogen gas, and examined again for luminance. From these measurement values, the proportion of each device's luminance retained after 100-hour continuous operation (to the initial luminance, expressed as percent) was calculated. These calculation results are shown in Table 6.

TABLE 5

| | Wavelength of | | Condition of |
|---|---|---|---|
| | light | Luminance under | light |
| | emission λmax | applied voltage | emitting |
| Device No. | (nm) | of 18 V (cd/m²) | surface^{*)} |
| 201 (comparison) | 521 | 220 | bad |
| 202 (comparison) | 521 | 180 | bad |
| 203 (comparison) | 522 | 190 | bad |
| 204 (invention) | 522 | 2000 | good |
| 205 (invention) | 521 | 2200 | good |

^{*)}Evaluation by visual observation

TABLE 6

| | Proportion of luminance retained after |
|---|---|
| | continuous operation (to initial |
| Device No. | value), expressed as percent |
| 201 (comparison) | 11 |
| 202 (comparison) | 18 |
| 203 (comparison) | 19 |
| 204 (invention) | 85 |
| 205 (invention) | 88 |

The results shown in Table 4 indicate that the luminance of the device No 201 and that of every other device were equivalent. However, as can be seen from the results shown in Tables 5 and 6, the present compound-using devices Nos. 204 and 205 were far superior to the devices Nos. 201 to 203 as comparative samples in durability to withstand not only the storage under high temperature conditions but also continuous operation under the testing condition mentioned above. These results prove clearly that the present compounds containing many asymmetric carbon atoms compared with comparative compounds can achieve beneficial effects.

### EXAMPLE 3

A transparent substrate was prepared by forming a 150 nm-thick ITO film on a glass support whose dimensions were 25 mm by 25 mm by 0.7 mm (produced by Tokyo Sanyo Vacuum Industries Co., Ltd.) and then etched and followed by washing. Onto this substrate, copper phthalocyanine was evaporated in a film having a thickness of about 10 nm. Onto the substrate thus processed, about 40 nm-thick film of N,N′-bis(1-naphthyl)-N,N′-diphenylbenzidine (NPD), about 20 nm-thick film of tris(8-hydroxyquinolinato) aluminum (Alq) and about 40 nm-thick film of 2, 5-bis (1-naphthyl) -1,3, 5-oxadiazole (DNPB) were evaporated in order of description under a condition that the pressure inside the vacuum evaporation apparatus was reduced to 10⁻³ to 10⁻⁴ Pa and the substrate temperature was kept at ambient temperature. On the thus formed laminate of organic compounds, a patterned mask (for adjusting each emission area to 5 mm×5 mm) was placed and further, inside the vacuum evaporation apparatus, Mg and Ag were evaporated simultaneously in a Mg/Ag ratio of 10/1 to form a metallic film having a thickness of 250 nm, followed by evaporation of a 300 nm-thick Ag film. Thus, an EL device No. 101′ (a comparative sample) was made.

Then, EL devices Nos. 102′ to 110′ were further made in the same manner as the EL device No. 101′, except that three different compounds for comparison and six different compounds according to the invention were used respectively in place of DNPB.

Each of the thus made EL devices was made to luminesce by applying thereto a DC constant voltage by means of a source measure unit, Model 2400, made by Toyo Technica Co., Ltd., and examined for luminance and wavelength of light emission by using a luminometer BM-8 made by Topcon Co. and a spectrum analyzer PMA-11 made by Hamamatsu Photonics Co., respectively. The results obtained are shown in Table 7.

TABLE 7

| | | | Luminance | |
|---|---|---|---|---|
| | Electron | Wavelength of | under applied | |
| | transport | light emission | voltage of 10 V | |
| Device No. | material | λmax (nm) | (cd/m²) | |
| 101′ (comparative) | DNPB | 524 | 3400 | |
| 102′ (comparative) | A′ | 523 | 3200 | |
| 103′ (comparative) | B′ | 525 | 3300 | |
| 104′ (comparative | | C′ | 526 | 3250 |
| 105′ (invention) | ET-2 | 524 | 3500 | |
| 106′ (invention) | ET-4 | 525 | 3550 | |
| 107′ (invention) | ET-5 | 524 | 3300 | |
| 108′ (invention) | ET-7 | 526 | 3550 | |
| 109′ (invention) | ET-11 | 525 | 3600 | |
| 110′ (invention) | ET-19 | 524 | 3650 | |

Comparative Compound A′

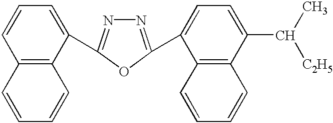

Comparative Compound B′

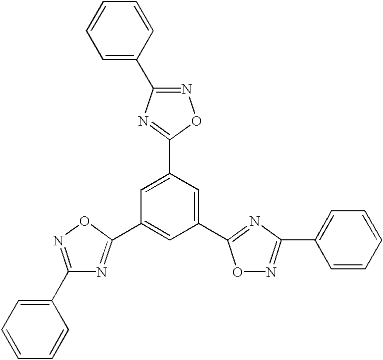

Comparative Compound C′

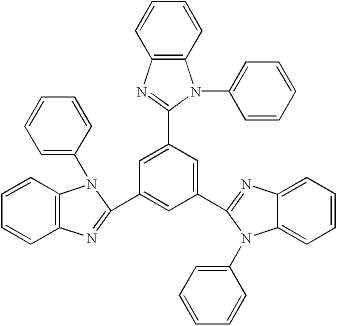

These devices were sealed up inside an autoclave filled with argon gas, and allowed to stand for 10 days as the inside temperature was kept at 85° C. by heating. Thereafter, the luminance measurement of each device was carried out in the same way as mentioned above, and the condition of the light emitting surface of each device was observed. The results obtained are shown in Table 8. Further, the operation of each device at a constant voltage of 10 V was continued for 100 hours in a glove box the inside air of which was in advance replaced by nitrogen gas, and examined again for luminance. From these measurement values, the proportion of each device's luminance retained after 100-hour continuous operation (to the initial luminance, expressed as percent) was calculated. These calculation results are shown in Table 9.

TABLE 8

| | Wavelength of | Luminance | Condition of |
|---|---|---|---|
| | light | under applied | light |
| | emission λmax | voltage of 10 V | emitting |
| Device No. | (nm) | (cd/m²) | surface^{*)} |
| 101′ (comparison) | 524 | 250 | bad |
| 102′ (comparison) | 525 | 1250 | so-so |
| 103′ (comparison) | 524 | 2200 | so-so |
| 104′ (comparison) | 525 | 2100 | so-so |
| 105′ (invention) | 526 | 3500 | good |
| 106′ (invention) | 525 | 3450 | good |
| 107′ (invention) | 524 | 3200 | good |
| 108′ (invention) | 525 | 3500 | good |
| 109′ (invention) | 526 | 3550 | good |
| 110′ (invention) | 525 | 3600 | good |

^{*)}Evaluation by visual observation

TABLE 9

| | Proportion of luminance retained after |
|---|---|
| | continuous operation (to initial |
| Device No. | value), expressed as percent |
| 101′ (comparison) | 14 |
| 102′ (comparison) | 58 |
| 103′ (comparison) | 63 |
| 104′ (comparison) | 75 |
| 105′ (invention) | 94 |
| 106′ (invention) | 96 |
| 107′ (invention) | 96 |
| 108′ (invention) | 93 |
| 109′ (invention) | 95 |
| 110′ (invention) | 96 |

The results shown in Table 7 indicate that the device No. 101′ and every other device were equivalent in luminance. However, as can be seen from the results shown in Tables 8 and 9, the present compound-using devices Nos. 105′ to 110′ were significantly superior to the devices Nos. 101′ to 104′ as the comparative samples in durability to withstand not only the storage under high temperature conditions but also continuous operation under the testing condition mentioned above. These results prove clearly that the present compounds containing many asymmetric carbon atoms compared with the comparative compounds can achieve beneficial effects.

### EXAMPLE 4

On the ITO glass substrate etched and washed in the same manner as in Example 3 was spin-coated a solution prepared by dissolving 40 mg of poly(N-vinylcarbazole) (PVK), 12 mg of 2,5-bis(l-naphthyl)-1,3,4-oxadiazole (DNPB) and 10 mg of coumarin-6 in 3 ml of 1,2-dichloroethane. The thickness of the thus formed organic layer was about 120 nm. Then, the cathode was evaporated onto the organic layer in the same manner as in Example 3 to make an EL device No. 201′.

Then, EL devices Nos. 202′ to 205′ were further made in the same manner as the EL device No. 201′, except that two different compounds for comparison and two different compounds according to the invention were used respectively in place of DNPB.

Each of the thus made EL devices was made to luminesce by applying thereto a DC constant voltage by means of a source measure unit, Model 2400, made by Toyo Technica Co., Ltd., and examined for luminance and wavelength of light emission by using a luminometer BM-8 made by Topcon Co. and a spectrum analyzer PMA-11 made by Hamamatsu Photonics Co., respectively. The results obtained are shown in Table 10.

TABLE 10

| | | | Luminance |
|---|---|---|---|
| | Electron | Wavelength of | under applied |
| | transport | light emission | voltage of 18 V |
| Device No. | material | λmax (nm) | (cd/m²) |
| 201′ (comparative) | DNPB | 521 | 2550 |
| 202′ (comparative) | A′ | 520 | 2500 |
| 203′ (comparative) | B′ | 521 | 2550 |
| 204′ (invention) | ET-1 | 521 | 2650 |
| 205′ (invention) | ET-9 | 522 | 2600 |

These devices were sealed up inside an autoclave filled with argon gas, and allowed to stand for 10 days as the inside temperature was kept at 85° C. by heating. Thereafter, the luminance measurement of each device was carried out in the same way as mentioned above, and the condition of the light emitting surface of each device was observed. The results obtained are shown in Table 11. Further, the operation of each device at a constant voltage of 10 V was continued for 100 hours in a glove box the inside air of which was in advance replaced by nitrogen gas, and examined again for luminance. From these measurement values, the proportion of each device's luminance retained after 100-hour continuous operation (to the initial luminance, expressed as percent) was calculated. These calculation results are shown in Table 12.

TABLE 11

| | Wavelength of | Luminance | Condition of |
|---|---|---|---|
| | light | under applied | light |
| | emission λmax | voltage of 18 V | emitting |
| Device No. | (nm) | (cd/m²) | surface^{*)} |
| 201′ (comparison) | 521 | 240 | bad |
| 202′ (comparison) | 520 | 200 | bad |
| 203′ (comparison) | 522 | 220 | bad |
| 204′ (invention) | 521 | 2200 | good |
| 205′ (invention) | 520 | 2300 | good |

^{*)}Evaluation by visual observation

TABLE 12

| | Proportion of luminance retained after |
|---|---|
| | continuous operation (to initial |
| Device No. | value), expressed as percent |
| 201′ (comparison) | 14 |
| 202′ (comparison) | 22 |
| 203′ (comparison) | 25 |
| 204′ (invention) | 89 |
| 205′ (invention) | 91 |

The results shown in Table 10 indicate that the luminance of the device No. 201′ and that of every other device were equivalent. However, as can be seen from the results shown in Tables 11 and 12, the present compound-using devices Nos. 204′ and 205′ were far superior to the devices Nos. 201′ to 203′ as comparative samples in durability to withstand not only the storage under high temperature conditions but also continuous operation under the testing condition mentioned above. These results prove clearly that the present compounds containing asymmetric carbon atoms can achieve beneficial effects, compared with asymmetric carbon-free comparative compounds.

By the use of compounds according to the invention, the light emitting devices can have high luminance and achieve remarkable improvement in durability to withstand not only the storage at high temperatures but also continuous operation.

What is claimed is:

1. An organic light emitting device material comprising at least one compound having at least two asymmetric carbon atoms per a molecule.

2. The organic light emitting device material according to claim 1, wherein the compound comprises at least one primary, secondary or tertiary amine moiety.

3. The organic light emitting device material according to claim 1, wherein the compound is a π-electron-rich condensed or uncondensed aromatic heterocyclic compound having at least two asymmetric carbon atoms per a molecule.

4. The organic light emitting device material according to claim 3, wherein the compound is a hole-transporting compound.

5. The organic light emitting device material according to claim 1, wherein the compound is an electron-deficient aromatic heterocyclic compound having at least two asymmetric carbon atoms per a molecule.

6. The organic light emitting device material according to claim 5, wherein the compound is an electron-transporting compound.

7. The organic light emitting device material according to claim 5, wherein the electron-deficient aromatic heterocyclic compound comprises at least one condensed or uncondensed 5-membered aromatic heterocyclic ring in which at least two hetero atoms including at least one nitrogen atom are contained.

8. The organic light emitting device material according to claim 5, wherein the electron-deficient aromatic heterocyclic compound comprises at least one condensed or uncondensed nitrogen-containing 6-membered aromatic heterocyclic ring.

9. The organic light emitting device material according to claim 1, wherein the compound has a molecular weight of from 100 to 10,000.

10. An organic light emitting device comprising one pair of electrodes and at least one layer between the electrodes, wherein the layer comprises at least one compound having at least two asymmetric carbon atoms per a molecule.

11. The organic light emitting device according to claim 10, wherein the layer containing the compound is a hole transport layer, a hole injection layer, an electron transport layer, an electron injection layer or a light emitting layer.

12. The organic light emitting devise according to claim 10, wherein the layer containing the compound is a hole transport layer.

13. The organic light emitting devise according to claim 12, wherein the compound comprises at least one primary, secondary or tertiary amine moiety.

14. The organic light emitting devise according to claim 12, wherein the compound is a π-electron-rich condensed or uncondensed aromatic heterocyclic compound having at least two asymmetric carbon atoms per a molecule.

15. The organic light emitting device according to claim 10, wherein the layer containing the compound is an electron transport layer.

16. The organic light emitting devise according to claim 15, wherein the compound is an electron-deficient aromatic heterocyclic compound having at least two asymmetric carbon atoms per a molecule.

17. The organic light emitting device according to claim 14, wherein the π-electron-rich condensed or uncondensed aromatic heterocyclic compound is a 5-membered aromatic heterocyclic compound containing one hetero atom in their rings each, a compound formed by fusing two of them together, or a compound formed by fusing two of them together, or a compound formed by fusing one of them and one or more of aromatic hydrocarbon rings.

18. The organic light emitting devise according to claim 14, wherein the π-electron-rich condensed or uncondensed aromatic heterocyclic compound is a pyrrole, a thiophene, a furan, an indole, a carbazole, a benzothiophene, a benzofuran, a dibenzothiophene, a dibenzofuran or an indolizine.

19. The organic light emitting devise according to claim 10, wherein the compound has at least two substituent group containing asymmetric carbon atoms.

20. The organic light emitting device according to claim 19, wherein the substituents group is a sec-butyl group, a 2-ethylhexyl group, an α-substituted benzyl group, or a group derived from an amino acid.

21. A primary, secondary or tertiary amine compound comprising at least two asymmetric carbon atoms per a molecule.

22. A condensed or uncondensed π-electron-rich aromatic heterocyclic compound having at least two asymmetric carbon atoms per a molecule.

23. An electron-deficient aromatic heterocyclic compound having at least two asymmetric carbon atoms per a molecule.

24. The electron-deficient aromatic heterocyclic compound according to claim 23, which comprises at least one condensed or uncondensed aromatic 5-membered heterocyclic ring in which at least two hetero atoms including at least one nitrogen atom are contained.

25. An electron-deficient aromatic heterocyclic compound according to claim 23, which comprises at least one condensed or uncondensed nitrogen-containing aromatic 6-membered heterocyclic ring.
